(19) United States
(12) Patent Application Publication
(10) Pub. No.: US 2005/0172322 A1
(43) Pub. Date: Aug. 4, 2005

(54) Wireless CATV transmitter and receiver system

(76) Inventor: David Rich Howard, Dothan, AL (US)

Correspondence Address: JACOBSON HOLMAN PLLC, 400 SEVENTH STREET N.W., SUITE 600, WASHINGTON, DC, 20004, US

(21) Appl. No.: 10/969,171

(22) Filed: Oct. 21, 2004

Related U.S. Application Data
(60) Provisional application No. 60/512,842, filed on Oct. 21, 2003.

(51) Int. Cl. H04N 7/173; H04N 5/44; H04N 7/18

(52) U.S. Cl. 725/81; 348/725; 725/80; 725/100

(57) ABSTRACT

A wireless CATV transmitter and receiver system. The transmitter has a built-in CATV tuner and wireless transmitter for instantaneous transmission of cable television channels to the wireless receiver which receives the transmitted wireless signals and conveys them to a video viewing device such as a television or computer.

### BACKGROUND OF THE INVENTION

1. Field of the Invention

The present invention is related to the field of wireless communication and, more particularly, to a device for viewing cable television as well as other video signals received over a wireless connection.

2. Description of the Related Art

Cable television requires the installation of cable from a distribution center to those devices upon which cable programming is to be viewed. This makes installation a relatively time-consuming and expensive process. Further, such a fixed infrastructure is not always practical, particularly with portable viewing devices.

### SUMMARY OF THE INVENTION

In view of the foregoing, one object of the present invention is to overcome the limitations of cable viewing by providing a wireless CATV transmitter and receiver system that enables cable programming to be viewed on any video viewing device having standard input ports without the need to run cable.

Another object of the the present invention is to provide a wireless CATV kit designed to connect to existing communications equipment for transmission of cable television channels to a non-cable-equipped television or computer for cable video viewing via wireless connection.

In accordance with these and other objects, the present invention is directed to a wireless CATV transmitter and receiver system. The transmitter unit has a built-in CATV tuner and wireless transmitter for instantaneous wireless transmission of cable television channels and other signals to the receiver which receives the transmitted signals and conveys them to a video viewing device such as a television or computer.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 illustrates the wireless transmitter and receiver system in accordance with the present invention.

FIG. 2 is a block diagram of the transmitter unit of FIG. 1.

FIG. 3 is a block diagram of the receiver of FIG. 1.

FIG. 4 is a block diagram of a receiver module built into the transmitter unit for receiving infrared signals from a remote control.

FIG. 5 is a block diagram of a receiver module built into the transmitter unit for receiving RF signals from a remote control.

FIG. 6 is a representative schematic of the transmitter unit in accordance with the present invention.

FIG. 7 is a representative schematic of the receiver in accordance with the present invention.

FIG. 8 is a representative schematic of a receiver module in accordance with the present invention.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawing. Also, in describing the preferred embodiments, specific terminology will be resorted to for the sake of clarity. It is to be understood that each specific term includes all technical equivalents which operate in a similar manner to accomplish a similar purpose.

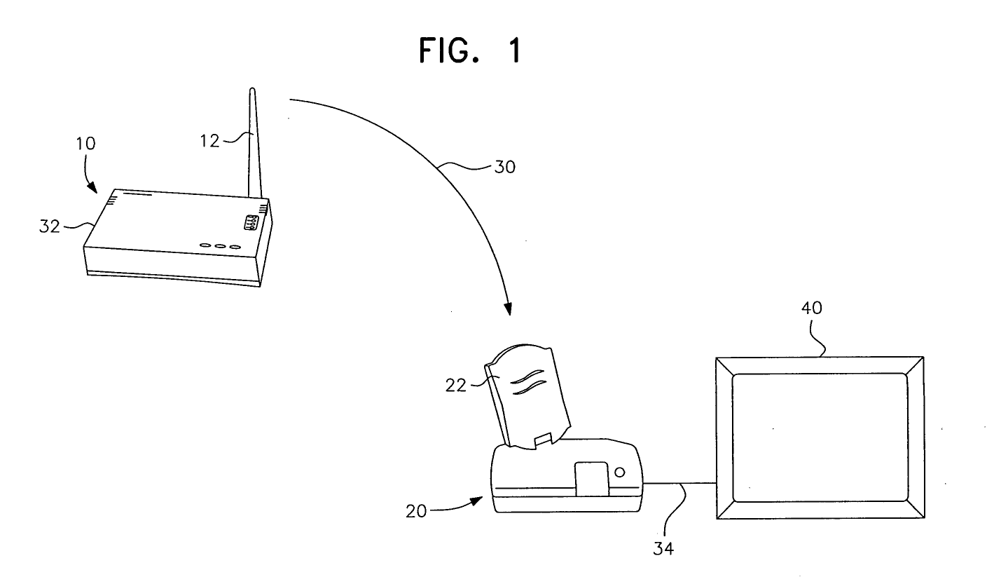

As shown in FIG. 1, the present invention is directed to an audio and video communication system including a wireless transmitter unit, generally designated by the reference numeral 10, and a wireless receiver, generally designated by the reference numeral 20. The tranmitter unit 10 communicates wirelessly with the receiver 20 over a communications channel 30.

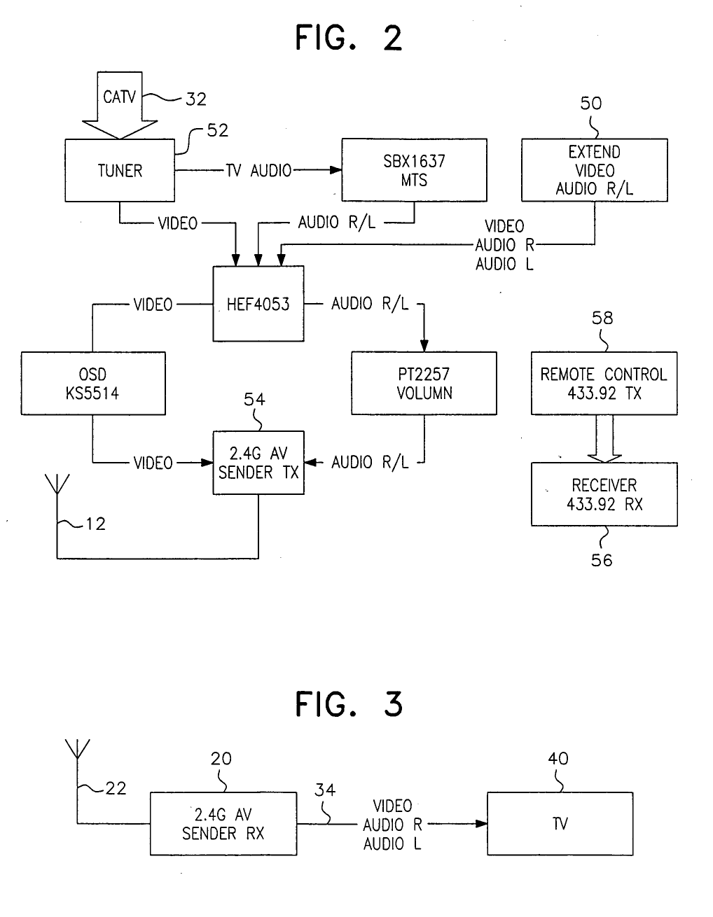

The transmitter unit 10 is provided with an “F” connector on the rear or side panel thereof for connection of standard cable 32 as used by cable providers. As shown in more detail in FIG. 2, the transmitter unit 10 also has an A/V composite input 50 on the rear or side panel for connection to a DVD player, a camera, etc. Using a built-in CATV tuner 52, the transmitter unit 10 processes audio and video signals from the cable 32, as well as any of the audio and/video signals that may be received over the A/V composite input 50, for wireless transmission using a 2.4 GHz transmitter 54 via the antenna 12 to the receiver 20 over the communications channel 30. The transmitter unit 10 also includes a receiver module 56 for receiving input from a remote control transmitter 58. The remote control transmitter 58 is used by the person viewing the wirelessly transmitted signal to change the tuner 52 or the frequency on the transmitter unit 10 as is known by persons of ordinary skill in the art.

The receiver 20 receives signals transmitted wirelessly from the transmitter 54 via antenna 22. As also shown in the block diagram of FIG. 3, the receiver 20, in turn, is connected to a video device 40, such as a television or computer, by cable devices such as an RCA or USB cable 34 using the ports already provided in the pertinent video device 40. The signals received wirelessly from the transmitter unit 10 are then conveyed to the video device 40 through the cable 34, enabling the viewer to watch full cable television, as well as any other signals transmitted wirelessly over the communications channel 30, without the need to physically run cable to the video device 40.

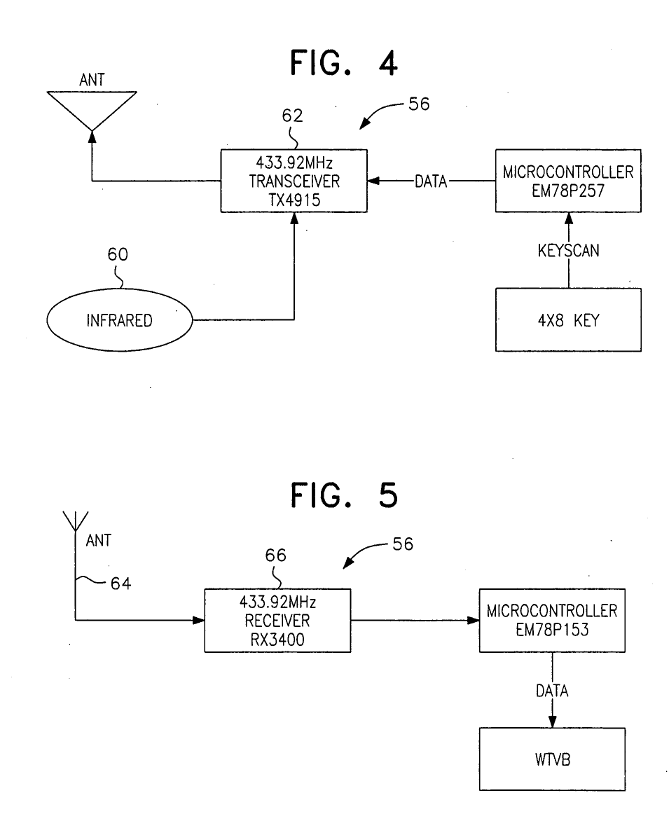

FIGS. 4 and 5 illustrate basic components of the receiver module 56 that is built into the transmitter unit 10 for receiving input from the remote control transmitter 58. These inputs can include infrared signals 60 for changing the frequency of the transmitter unit 10 through 433.92 MHz transceiver 62, as well as RF signals 64 for changing the tuner channel through 433.92 MHz receiver 66. As already noted, the person viewing the video device 40 is able to control the channel on the tuner as well as the RF frequency of the transmitter unit 10 using the remote control transmitter 58 to send the appropriate signal to the transmitter unit 10 where it is received by the receiver module 56. The structure and function of such remote control transmitters and receiver modules is known by persons of ordinary skill in the art.

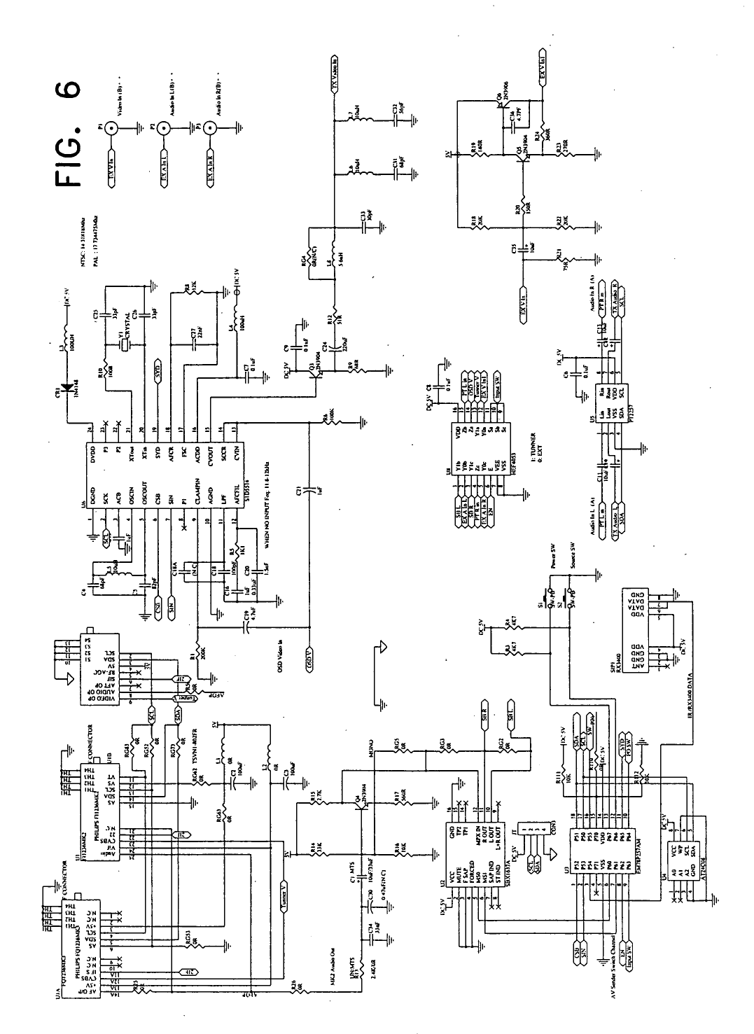

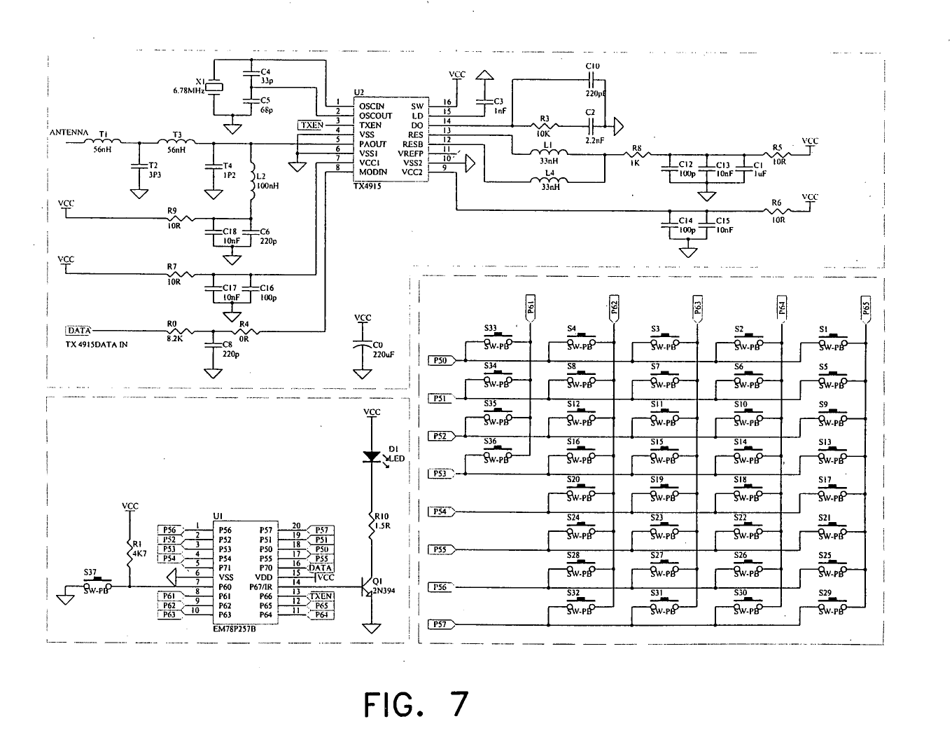

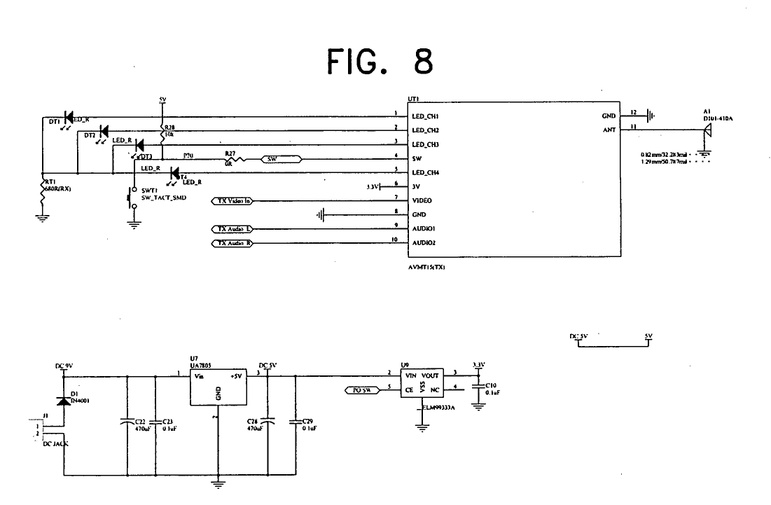

Schematics of the circuit layouts of the transmitter unit, receiver and receiver module are provided in FIGS. 6, 7 and 8, respectively. These circuit layouts are representative only as persons of ordinary skill in the art would know of alternative layouts that would also achieve the desired function.

The present invention is fully portable, the transmitter and receiver being quickly and easily connectable to any cable outlet and video viewing device, respectively, to provide great flexibility in cable viewing capability and location.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. An audio and video communication system comprising:
a wireless transmitter unit having a built-in cable television tuner, said transmitter unit including a connector for coupling to standard cable used by cable television providers to transmit cable television programming; and
a wireless receiver for receiving wireless signals transmitted by said wireless transmitter unit, said receiver including a connector for wired connection to a video viewing device;
said transmitter unit using said built-in cable television tuner to process audio and video signals received via said standard cable for wireless transmission of a cable television signal to said receiver over a communications channel, said receiver wirelessly receiving said cable television signal on said communications channel and conveying said cable television signal over said wired connection to said video viewing device for cable television viewing.

2. The communication system as set forth in claim 1, wherein said video viewing device is a television.

3. The communication system as set forth in claim 1, wherein said video viewing device is a computer.

4. The communication system as set forth in claim 1, wherein said wired connection between said receiver and said video viewing device is an RCA cable.

5. The communication system as set forth in claim 1, wherein said wired connection between said receiver and said video viewing device is a USB cable.

6. The communication system as set forth in claim 1, wherein said transmitter unit and said receiver are fully portable, being connectable to any standard cable outlet and video viewing device, respectively.

7. The communication system as set forth in claim 1, wherein said transmitter unit includes an A/V composite input for connection to a DVD player, input from said DVD player being processed by said transmitter unit and transmitted to said receiver for viewing on said video viewing device.

8. The communication system as set forth in claim 1, wherein said transmitter unit includes an A/V composite input for connection to a camera, input from said camera being processed by said transmitter unit and transmitted to said receiver for viewing on said video viewing device.

9. An audio and video communication system comprising:
a standard cable coupled to a cable distibution center for wired transmission of cable television programming from said cable distribution center;
a transmitter unit coupled to said standard cable for receiving cable programming over said cable, said transmitter unit having a built-in cable television tuner for processing audio and video signals received via said standard cable, said transmitter unit wirelessly transmitting said processed audio and video signals over a wireless communications channel;
a video viewing device for viewing video programming, said video viewing device having no wired connection to said transmitter unit and having no ground-line cable connection to a cable distribution center for receiving cable programming;
a receiver coupled to said video viewing device and having no wired connection to said transmitter unit, said receiver receiving cable programming signals wirelessly transmitted by said transmitter unit over said wireless communications channel, and said receiver conveying said cable programming signals to said video viewing device coupled thereto for viewing of cable programming on said video viewing device.

10. The communication system as set forth in claim 9, wherein said video viewing device is a television.

11. The communication system as set forth in claim 9, wherein said video viewing device is a computer.

12. The communication system as set forth in claim 9, wherein said receiver and said video viewing device are coupled with an RCA cable.

13. The communication system as set forth in claim 9, wherein said receiver and said video viewing device are coupled with a USB cable.

14. The communication system as set forth in claim 9, wherein said transmitter unit and said receiver are fully portable, being connectable to any standard cable outlet and video viewing device, respectively.

15. The communication system as set forth in claim 9, wherein said transmitter unit includes an A/V composite input for connection to a DVD player, input from said DVD player being processed by said transmitter unit and transmitted to said receiver over said wireless communications channel for viewing on said video viewing device.

16. The communication system as set forth in claim 9, wherein said transmitter unit includes an A/V composite input for connection to a camera, input from said camera being processed by said transmitter unit and transmitted to said receiver over said wireless communication channel for viewing on said video viewing device.
